(19) United States
(12) Patent Application Publication
(10) Pub. No.: US 2007/0002088 A1
(43) Pub. Date: Jan. 4, 2007

(54) Inkjet image forming apparatus and method of maintaining a print head of the same

(75) Inventor: Jin-wook Jeong, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/450,370

(22) Filed: Jun. 12, 2006

(30) Foreign Application Priority Data
Jul. 4, 2005 (KR) 2005-59670

(51) Int. Cl. B41J 29/38

(52) U.S. Cl. 347/12

(57) ABSTRACT

An inkjet image forming apparatus and a method of maintaining a printhead of the same. The inkjet image forming apparatus includes a printhead installed along a first direction with respect to a print medium that is transferred along a second direction, and includes a nozzle unit with a length corresponding to a width of the print medium and maintenance regions including a first maintenance region disposed at a first side of a longitudinal direction of the printhead and a second maintenance region disposed at a second side opposite to the first side. In the method of maintaining the printhead of the inkjet image forming apparatus, the printhead is reciprocally moved for printing according to distances between ends of the first and second sides of the print medium and adjacent boundaries of a printing area and widths of the maintenance regions. A lifespan of the printhead can be increased by controlling each nozzle in the printhead to evenly eject ink. In addition, a maintenance operation is performed on unused nozzles during printing, thereby increasing the lifespan of the printhead and printing quality.

### CROSS-REFERENCE TO RELATED APPLICATIONS

This application claims the benefit of Korean Patent Application No. 2005-59670, filed on Jul. 4, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus and a method of maintaining a printhead of the same, the method preventing a concentration of an ejecting load on the printhead and separately maintaining an unused nozzle unit during printing.

2. Description of the Related Art

An inkjet image forming apparatus forms images by ejecting ink from a printhead, which is positioned a predetermined distance apart from a print medium and reciprocally moves in a direction perpendicular to a transferring direction of the print medium. This inkjet image forming apparatus is referred to as “a shuttle type inkjet image forming apparatus.”

Recently, a printhead having a nozzle unit with a length corresponding to a width of the print medium has been used to obtain high-speed printing. An image forming apparatus operated in this manner is referred to as a “line printing type inkjet image forming apparatus.” In the line printing type inkjet image forming apparatus, the printhead is fixed and only the print medium is transferred. Accordingly, a driving device of the inkjet image forming apparatus is simple and high-speed printing can be performed. However, since the printhead is fixed, unused nozzles may exist in accordance with a size of a print medium (for example, A4 size or letter size). In addition, a marginal area of the print medium is not actually printed, and thus nozzles positioned in the marginal area are not used. Accordingly, if a nozzle that is previously unused for a long period begins to operate, the nozzle may not properly eject ink.

A maintenance operation, such as spitting or wiping, is not easily performed for nozzles positioned out of a typical printing range. In addition, if a nozzle is unused and exposed for a long period, the nozzle may be blocked by dried ink, and may become unusable. Furthermore, since the printhead is fixed and ejects ink, ejecting loads are concentrated on certain nozzles such that a lifespan of the printhead is determined by a frequency of use of the certain nozzles, not all of the nozzles. Thus, the lifespan of the printhead is decreased. Therefore, an inkjet image forming apparatus having an improved structure to overcome such limitations is needed.

### SUMMARY OF THE INVENTION

The present general inventive concept provides an inkjet image forming apparatus having a movable printhead to prevent a concentration of ejection loads on certain nozzles and a method of maintaining the printhead of the inkjet image forming apparatus.

The present general inventive concept also provides an inkjet image forming apparatus and a method of maintaining a printhead of the same, which can separately maintain unused nozzles during printing.

Additional aspects of the present general inventive concept will be set forth in part in the description which follows and, in part, will be obvious from the description, or may be learned by practice of the general inventive concept.

The foregoing and/or other aspects of the present general inventive concept may also be achieved by providing an image forming apparatus including a printhead installed along a first direction with respect to a print medium that is transferred along a second direction and having a nozzle unit with a length corresponding to a width of the print medium, maintenance regions including a first maintenance region disposed at a first side of a longitudinal direction of the printhead and a second maintenance region disposed at a second side opposite to the first side, a carriage in which the printhead is mounted, a carriage moving unit to reciprocally move the carriage between the first and the second maintenance regions, and a control unit which generates a control signal to control operations of the printhead and the carriage moving unit to determine an ejecting position of the nozzle unit according to a position of the printhead moved by the carriage moving unit.

The control unit may include a memory unit to store image data input from an external device, a printing area determination unit to read the image data from the memory unit, and to calculate distances from ends of the first and second sides of the print medium to respective adjacent boundaries of a printing area where the image data is printed by reading the image data from the memory unit, and an ejecting position determination unit to compare the distances between the ends of the first and second sides of the print medium and the respective adjacent boundaries of the printing area with widths of the maintenance regions, and to determine the ejecting position of the nozzle unit.

The control unit may generate a control signal to move the carriage toward the second side such that the nozzles at the end of the first side of the nozzle unit print to an end of the first side of the printing area when the distance between the end of the first side of the print medium and the respective adjacent boundary of the printing area is shorter than the widths of the maintenance regions. The control unit may generate a control signal to move the carriage to the first side such that nozzles at an end of the second side of the nozzle unit print to an end of the second side of the printing area after printing a predetermined area of the print medium.

The control unit may generate a control signal to move an end of the second side of the carriage to an end of the second side of the second maintenance region and to determine the ejecting position of the nozzle unit to print the image data on the printing area when the distance between the end of the first side of the print medium and the respective adjacent boundary of the printing area is greater than or equal to the widths of the maintenance regions. The control unit may generate a control signal to move an end of the first side of the carriage to an end of the first side of the first maintenance region and to determine the ejecting position of the nozzle unit to print the image data on the printing area after printing to a predetermined area of the print medium.

The image forming apparatus may further include a maintenance unit disposed in the maintenance regions to maintain the nozzle unit in a standby state, and the control unit may generate a control signal to control the maintenance unit so that unused nozzles positioned in the maintenance regions are maintained in the standby state when a printing operation is being performed.

The control unit may generate a control signal to move the carriage after printing to a predetermined area of the print medium. The control unit may generate a control signal to move the carriage after printing one page of the print medium.

The control unit may generate a control signal to move the carriage by a moving distance such that the moving distance of the carriage varies each time the carriage is moved.

The image forming apparatus may further include a nozzle memory to store ejecting times of the nozzle unit in units of nozzles or predetermined groups of nozzles, and the control unit may generate a control signal to move the carriage according to information stored in the nozzle memory.

The foregoing and/or other aspects of the present general invention concept may also be achieved by providing an image forming apparatus, including a line array type printhead having a width that corresponds to a width of a printing medium, and a control unit to vary a position of the printhead along the width of the printing medium during one or more print operations such that an ejection load on nozzles in the printhead is not concentrated in one or more regions of the printhead.

The control unit may move the printhead to a first position for a first print operation and a second position for a second print operation with respect to the printing medium. The first print operation may include printing a first page of print data and the second print operation may include printing a second page of print data such that the control unit moves the printhead between the first and second positions while a first page of the printing medium on which the first print operation is performed is discharged and a second page of the printing medium is loaded under the printhead. The first and second print operations may include one of printing first and second groups of print lines, respectively, and performing first and second print jobs, respectively.

The control unit may move the printhead by a different amount along the width of the printing medium between print operations performed by the printhead.

The control unit may receive print data from an external device, determine a margin associated with the print data, move a first portion of the printhead within the margin to print a first predetermined portion of the print data while a second portion of the printhead is in a standby state outside the margin, and move the second portion of the printhead within the margin to print a second predetermined portion of the print data while the first portion of the printhead is in the standby state outside the margin.

The image forming apparatus may further include a carriage in which the printhead is mounted and being movable along a width of the printing medium, and a carriage moving unit having a motor and at least one guide rail along which the carriage is moved.

The control unit may include an ejecting position unit to receive print data from an external source and a current position of the printhead, and to generate head data to control selected nozzles in the printhead to print in a next print operation according to the received print data and the current position of the printhead.

The foregoing and/or other aspects of the present general invention concept may also be achieved by providing an image forming apparatus, including a printhead having a width that corresponds to a width of a print medium, a control unit to move the printhead between at least two positions, and an ejecting position determination unit to receive print data to be printed in a next print operation and a current position of the printhead, and to generate head data to control selected nozzles in the printhead to print in the next print operation based on the received print data and the current position of the printhead.

The foregoing and/or other aspects of the present general invention concept may also be achieved by providing an image forming apparatus, including a printhead having a plurality of nozzles, a support along which a print medium is transferred, at least one maintenance region disposed on at least one side of the support adjacent to the print medium, and a control unit to control nozzles in a first portion of the printhead to print a line of print data on the print medium while nozzles in a second portion of the printhead are maintained in the at least one maintenance region.

The at least one maintenance region may include a first maintenance region disposed at a first side of the print medium, a second maintenance region disposed at a second side of the print medium opposite to the first side, and a maintenance unit disposed in the first and second maintenance regions.

The control unit may receive print data to be printed on the print medium, move the printhead such that the first portion and a third portion of the printhead print a predetermined portion of the print data while the second portion of the printhead is maintained in the at least one maintenance region, and move the printhead such that the second and third portion of the printhead print another predetermined portion of the printhead while the first portion of the printhead is maintained in the at least one maintenance region.

The foregoing and/or other aspects of the present general invention concept may also be achieved by providing an image forming apparatus, including a printhead having a plurality of nozzles arranged along a width of a printing medium to perform one or more printing operations, and a control unit to receive print data, to determine a print area on the printing medium, and to move the printhead to alternate between at least two positions such that nozzles that perform the one or more printing operations and nozzles that are in a standby state are varied for each printing operation.

The image forming apparatus may further include a maintenance unit disposed adjacent to the printing medium to perform maintenance on one or more of the nozzles in the standby state.

The foregoing and/or other aspects of the present general invention concept may also be achieved by providing an image forming apparatus, including a print head having nozzles, a maintenance unit to maintain the nozzles, and a control unit to move the print head such that a portion of the nozzles is disposed in a printing area of a print medium to print and a second portion of the nozzles is disposed in the maintenance unit to perform a maintenance.

The foregoing and/or other aspects of the present general invention concept may also be achieved by providing an image forming apparatus, including a print head having nozzles, and a control unit to move the print head to choose a position with respect to a print medium, to determine a set of the nozzles of the print head to print according to the position of the print head with respect to the print medium.

The foregoing and/or other aspects of the present general invention concept may also be achieved by providing an apparatus to maintain a printhead of an inkjet image forming apparatus which includes maintenance regions having a first maintenance region disposed at a first side of a longitudinal direction of a printhead having a nozzle unit with a length corresponding to a width of a print medium and a second maintenance region disposed at a second side opposite to the first side, the apparatus including a print area unit to calculate distances between ends of the first and second sides of the print medium and respective adjacent boundaries of a printing area where image data is to be printed by analyzing the image data input from an external device, and an ejection nozzle position unit to determine an ejecting position of the printhead by comparing the distances between the ends of the first and second sides of the print medium and the respective adjacent boundaries of the printing area with widths of the maintenance regions.

The foregoing and/or other aspects of the present general inventive concept may also be achieved by providing a method of maintaining a printhead of an inkjet image forming apparatus which includes maintenance regions having a first maintenance region disposed at a first side of a longitudinal direction of a printhead having a nozzle unit with a length corresponding to a width of a print medium and a second maintenance region disposed at a second side opposite to the first side, the method including calculating distances between ends of the first and second sides of the print medium and respective adjacent boundaries of a printing area where image data is to be printed by analyzing the image data received from an external device, and determining an ejecting position of the printhead by comparing the distances between the ends of the first and second sides of the print medium and the respective adjacent boundaries of the printing area with widths of the maintenance regions.

The method may further include moving the printhead toward the second side for printing such that nozzles at an end of the first side of the nozzle unit print to an end of the first side of the printing area when the distance between the end of the first side of the print medium and the respective adjacent boundary of the printing area is shorter than the widths of the maintenance regions. The printhead may be moved toward the first side for printing such that nozzles at an end of the second side of the nozzle unit print to an end of the second side of the printing area after printing to a predetermined area.

The method may further include moving the end of the second side of the printhead toward an end of the second side of the second maintenance region for printing when the distance between the end of the first side of the print medium and the respective adjacent boundary of the printing area is greater than or equal to the widths of the maintenance regions. The method may further include moving the end of the first side of the printhead toward an end of the first side of the first maintenance region for printing after printing to a predetermined area of the print medium.

The method may further include maintaining the nozzle unit in a standby state in the maintenance regions and operating maintenance units disposed in the maintenance regions so that unused nozzles positioned in the maintenance regions may be maintained in a standby state when printing to the printing area.

The method may further include moving the printhead after printing to a predetermined area of the print medium. The method may further include moving the printhead after printing one page of the print medium.

The method may further include reciprocally moving the printhead wherein a moving distance of the printhead varies each time the printhead is moved.

The method may further include storing ejecting times of the nozzle unit in units of nozzles or predetermined groups of nozzles in a nozzle memory and performing the printing by moving the printhead according to information stored in the nozzle memory.

The foregoing and/or other aspects of the present general invention concept may also be achieved by providing a method of controlling an image forming apparatus having a printhead with a plurality of nozzles, a support along which a print medium is transferred, and at least one maintenance region disposed on at least one side of the support adjacent to the print medium, the method including controlling nozzles in a first portion of the printhead to print a line of print data on the print medium while nozzles in a second portion of the printhead are maintained in the at least one maintenance region.

The foregoing and/or other aspects of the present general invention concept may also be achieved by providing a method of controlling an image forming apparatus having a line array type printhead with a width that corresponds to a width of a printing medium, the method including controlling movement of the printhead to vary a position of the printhead along the width of the printing medium during one or more print operations such that an ejection load on nozzles in the printhead is not concentrated in one or more regions of the printhead.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a cross-sectional view illustrating an inkjet image forming apparatus according to an embodiment of the present general inventive concept;

FIG. 2 illustrates a printhead and maintenance regions of the inkjet image forming apparatus of FIG. 1;

FIG. 3 is an enlarged view illustrating the printhead of FIG. 2;

FIG. 4 is a perspective view illustrating a carriage moving unit according to an embodiment of the present general inventive concept;

FIG. 5 is a perspective view illustrating a carriage moving unit according to another embodiment of the present general inventive concept;

FIG. 6 is a perspective view illustrating a carriage moving unit according to yet another embodiment of the present general inventive concept;

FIG. 7 is a cross-sectional view illustrating the carriage moving unit of FIG. 6;

FIG. 8 is a block diagram illustrating a structure of an image forming apparatus according to an embodiment of the present general inventive concept;

FIG. 9 is a flowchart illustrating a method of maintaining a printhead according to an embodiment of the present general inventive concept;

FIGS. 10 and 11 illustrate operations of maintaining a printhead according to an embodiment of the present general inventive concept; and

FIGS. 12 and 13 illustrate operations of maintaining a printhead according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

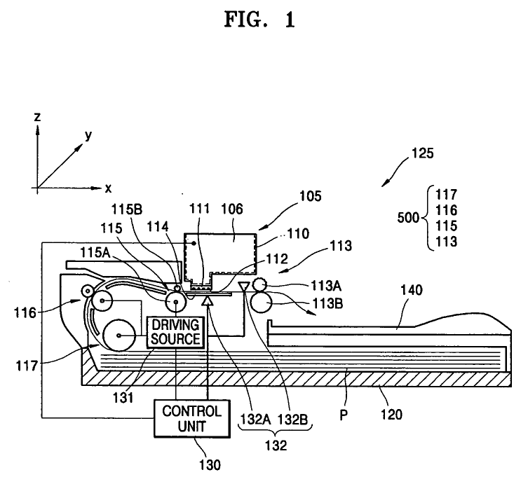

FIG. 1 is a cross-sectional view illustrating an inkjet image forming apparatus 125 according to an embodiment of the present general inventive concept.

Referring to FIG. 1, the inkjet image forming apparatus 125 includes a feeding cassette 120, a printhead unit 105, a supporting member 114 opposite to the printhead unit 105, a detecting unit 132 to detect a malfunctioning nozzle, a print medium transferring unit 500 to transfer a print medium P in a first direction (i.e., an x direction) and a stacking unit 140 on which a discharged print medium P is stacked. In addition, the inkjet image forming apparatus 125 further includes a control unit 130 to control operation of each component.

The print medium P is stacked on the feeding cassette 120. The print medium P is transferred from the feeding cassette 120 to a printhead 111 by the print medium transferring unit 500. The printhead 111 is associated with a nozzle unit 112 (or a plurality of nozzle units 112) and is disposed on a bottom surface of a body 110.

The print medium transferring unit 500 transfers the print medium P along a predetermined path and includes a pick-up roller 117, an auxiliary roller 116, a feeding roller 115, and a discharging roller 113. The print medium transferring unit 500 is driven by a driving source 131, such as a motor, and provides a transferring force to transfer the print medium P. The driving source 131 is controlled by the control unit 130, which will be described later. The pick-up roller 117 is installed in one side of the feeding cassette 120 and picks up the print medium P stacked in the feeding cassette 120. The feeding roller 115 is installed at an inlet side of the printhead 111 and feeds the print medium P drawn out by the pick-up roller 117 to the printhead 111. The feeding roller 115 includes a driving roller 115A to supply a transferring force to transfer the print medium P, and an idle roller 115B elastically engaged with the driving roller 115A. The auxiliary roller 116 that transfers the print medium P may be further installed between the pick-up roller 117 and the feeding roller 115. The discharging roller 113 is installed at an outlet side of the printhead 111 and discharges the print medium P on which the printing has been completed to an outside of the image forming apparatus 125.

The discharged print medium P is stacked on the stacking unit 140. The discharging roller 113 includes a star wheel 113A installed along a widthwise direction of the print medium P, and a supporting roller 113B which is opposite to the star wheel 113A and supports a rear side of the print medium P. The print medium P may wrinkle due to ink ejected onto a top side of the print medium P while passing through the nozzle unit 112. A predetermined distance between the print medium P and the nozzle unit 112 may not be maintained due to the wrinkles of the print medium P. The star wheel 113A prevents the print medium P fed under the nozzle unit 112 from contacting the bottom surface of the nozzle unit 112 or the body 110, or prevents the distance between the print medium P and the bottom surface of the nozzle unit 112 or the body 110 from being changed. The star wheel 113A is installed such that at least a portion of the star wheel 113A protrudes from the nozzle unit 112, and contacts at a point of the top surface of the print medium P.

The supporting member 114 is installed below the printhead 111 and supports the rear side of the print medium P to maintain the predetermined distance between the nozzle unit 112 and the print medium P. The predetermined distance between the nozzle unit 112 and the print medium P may be about 0.5-2.5 mm.

The detecting unit 132 detects malfunctioning nozzles of the nozzle unit 112 formed on the printhead 111. The detecting unit 132 includes a first detecting unit 132A to detect malfunctioning nozzles before printing and a second detecting unit 132B to detect malfunctioning nozzles during printing. The detecting unit 132 sends detection information to the control unit 130, which will be described later.

A printhead unit 105 prints an image by ejecting ink onto the print medium P, and includes the body 110, the printhead 111 installed in one side of the body 110, the nozzle unit 112 formed on the printhead 111, and a carriage 106 where the body 110 is mounted. The body 110 is mounted into the carriage 106 at a cartridge-type manner, and the carriage 106 is reciprocally movable along a second direction (i.e., a y direction) by a carriage moving unit 160, which will be described later. The feeding roller 115 is rotatably installed at an inlet side of the nozzle unit 112, and the discharging roller 113 is rotatably installed at an outlet side of the nozzle unit 112.

Although not illustrated, a removable cartridge type ink container is provided in the body 110. Further, the body 110 may include chambers, each of which has ejecting units (for example, piezoelectric elements or heat-driving typed heaters) that are connected to respective nozzles of the nozzle unit 112 and provide pressure to eject the ink, a passage (for example, an orifice) to supply the ink contained in the body 110 to each chamber, a manifold that is a common passage to supply the ink that flows through the passage to the chamber, and a restrictor that is an individual passage to supply the ink from the manifold to each chamber. The ejecting units, the chamber, the ejecting unit, the passage, the manifold, and the restrictor should be known to a person skilled in the art, and thus detailed descriptions thereof will not be provided. In addition, the ink container (not illustrated) may be separately installed from the printhead unit 105. The ink stored in the ink container may be supplied to the printhead unit 105 through a supplying unit like a hose.

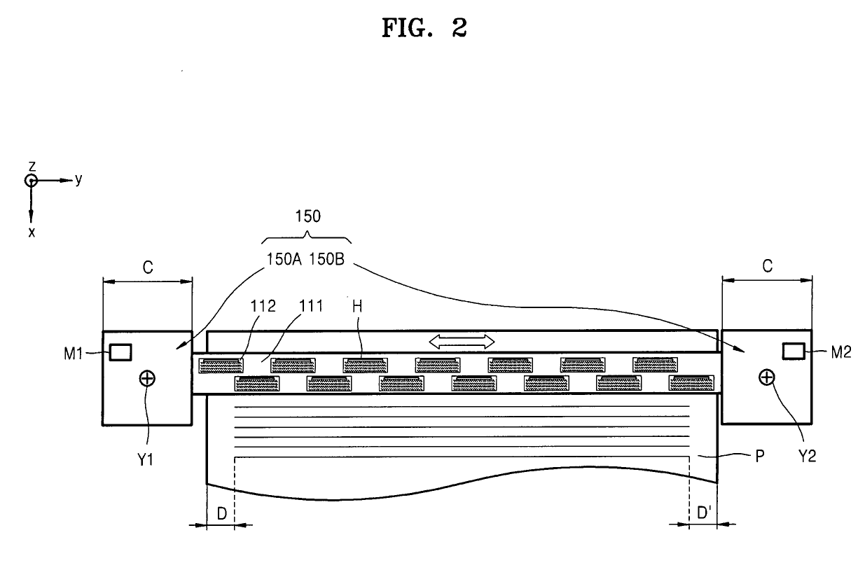

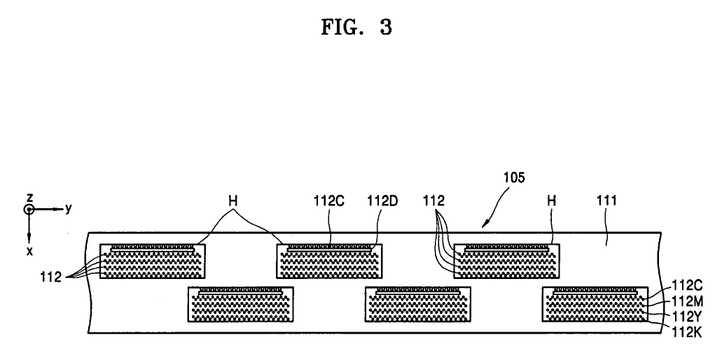

FIG. 2 illustrates the printhead 111 of FIG. 1 and maintenance regions 150. FIG. 3 illustrates the printhead 111 of FIG. 2. In FIG. 2, D indicates a distance between an end of a first side Y1 of the print medium P and an adjacent boundary of a printing area on the print medium P, D′ indicates a distance between an end of a second side Y2 of the print medium P and the other adjacent boundary of the printing area on the print medium P, and C indicates a width of the maintenance regions 150.

Referring to FIGS. 2 and 3, the printhead 111 is installed along the second direction (i.e., the y direction) with respect to the print medium P that is transferred along the first direction (i.e., the x direction) and includes the nozzle unit 112 longitudinally parallel with the printhead 111. The printhead 111 uses heat energy or a piezoelectric device as an ink ejecting source, and is made to have a high resolution through a semiconductor manufacturing process including, for example, etching, deposition, or sputtering.

The nozzle unit 112 has a length corresponding to or longer than the width of the print medium P. The nozzle unit 112 includes a plurality of head chips H each having nozzles, and the plurality of head chips are disposed along the second direction within a second length longer than the width of the print medium P. The nozzle unit 112 is reciprocally moved along the second direction (i.e., the y direction) by the carriage moving unit 160, which will be described later. The nozzle unit 112 may eject ink onto the print medium P in a stationary state, after moving. Thus, even though the printhead 111 may be a line type inkjet head extending along a width of the print medium P, the printhead 111 is still movable over the print medium P in the second direction.

Referring to FIG. 3, the plurality of head chips H having a plurality of nozzle rows arrays 112C, 112M, 112Y, and 112K may be formed in the printhead 111. Each of the head chips H has a driving circuit 112D which drives nozzles selectively or in units of a group of nozzles. The head chips H may be formed of one chip having a length equal to that of the printhead 111, (i.e., the width of the print medium P). The plurality of head chips H may be longitudinally arranged, as illustrated in FIG. 3. In addition, when the plurality of head chips H are arranged in a single line, a distance between the head chips H may become greater than a distance between the nozzles in the same head chips H, thereby generating an unprinted portion. Therefore, the plurality of head chips H may be arranged in a zigzag shape. The nozzle arrays among the nozzle arrays 112C, 112M, 112Y, and 112K in the head chip H which ejects ink of the same color, may be disposed to overlap with each other to enhance printing resolution in the second direction (i.e., the y direction). In this case, ink dots ejected by the nozzles in the nozzle arrays are deposited on positions between ink dots ejected by the nozzles in the other nozzle arrays, thereby enhancing the printing resolution in the second direction (i.e., the y direction). The printhead 111 having the nozzle unit 112 of the plurality of head chips H is described as an example in the present embodiment, and it should be understood that the nozzle unit 112 may have other various shapes and/or arrangements. Although two nozzle arrays ejecting ink of the same color overlap with each other along the second direction in the present embodiment, one array may alternatively be arranged along the second direction. Therefore, the nozzle unit 112 illustrated in FIG. 3 is not intended to limit the scope of the present general inventive concept.

Each of the nozzles in the nozzle unit 112 includes the driving circuit 112D and a cable 112C to receive printing data, electric power, control signals, etc. The cable 112C may be a flexible printed circuit (FPC) or a flexible flat cable (FFC).

Referring to FIG. 2, the maintenance regions 150 include a first maintenance region 150A disposed at the first side Y1 and a second maintenance region 150B disposed at the second side Y2 opposite to the first side Y1. The first and second sides Y1 and Y2 used in the present description and claims indicate directions of the printhead 111, the print medium P, the nozzle unit 112, etc. That is, in the embodiment of FIG. 2, the first side Y1 indicates the left side of the printhead 111 and the second side Y2 indicates the right side of the printhead 111. Other orientations may also be used.

The maintenance regions 150 include one or more maintenance units M1 and M2. It is possible that one of the maintenance units M1 and M2 is installed in one of the maintenance regions 150. It is also possible that the maintenance units M1 and M2 may not be installed in the maintenance regions 150 but may be disposed at a position along the second direction. The maintenance unit maintains the nozzle unit 112 of the printhead 111 when printing is in a standby state for obtaining high printing quality, and includes a capping member (not illustrated) to cap the nozzle unit 112, a wiping member (not illustrated) to wipe the nozzle unit 112, and a waste ink reservoir to store ink apart from the nozzle unit 112 during a spitting operation. If all or a portion of nozzles are not used for a long period, ink on surfaces of the unused nozzles will dry and a viscosity of the ink is increased, thereby causing a problem in ejecting ink droplets. The spitting operation removes highly viscous ink by spitting a little amount of ink several times in predetermined intervals. The wiping operation removes liquid or even solidified residual ink around the nozzle by wiping the surface of the nozzle unit 112. If the amount of residual ink on the surface of the nozzle unit 112 is increased, the printing quality is significantly degraded caused by, for example, changing the pathways of the ink droplets. Therefore, the residual ink should be removed by, for example, the wiping member (not illustrated). The capping operation prevents the nozzle unit 112 from drying or being contaminated by covering the nozzle unit 112 when printing is in the standby state, or is not performed for a long period.

As described above, the maintenance unit (not illustrated) suitably maintains the nozzle unit 112 to obtain a high printing quality. Since the structure and operation of the maintenance unit should be known to those of ordinary skill in the art, a detailed description thereof will not be provided. In addition, the maintenance unit (not illustrated) is controlled by the control unit 130, which will be described later.

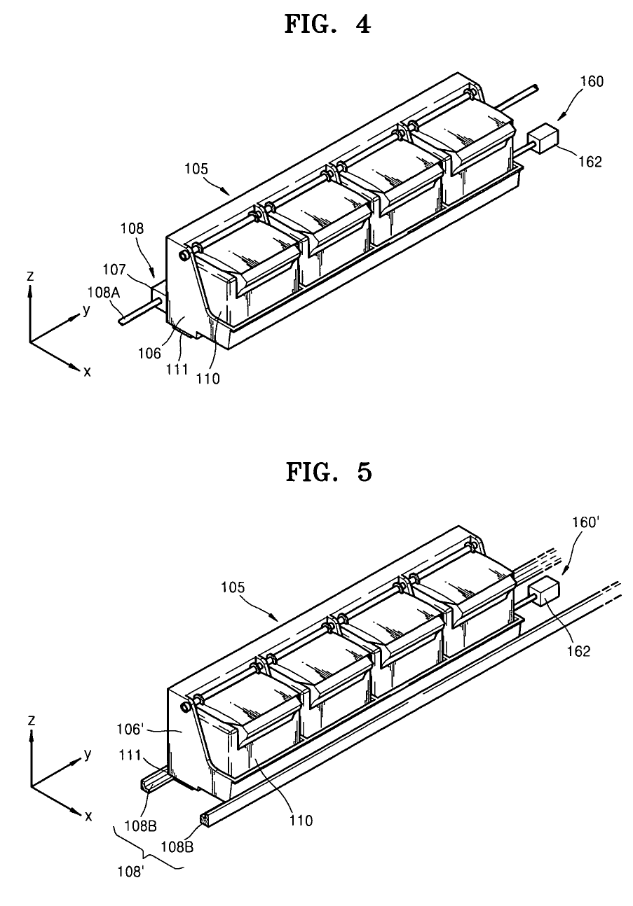

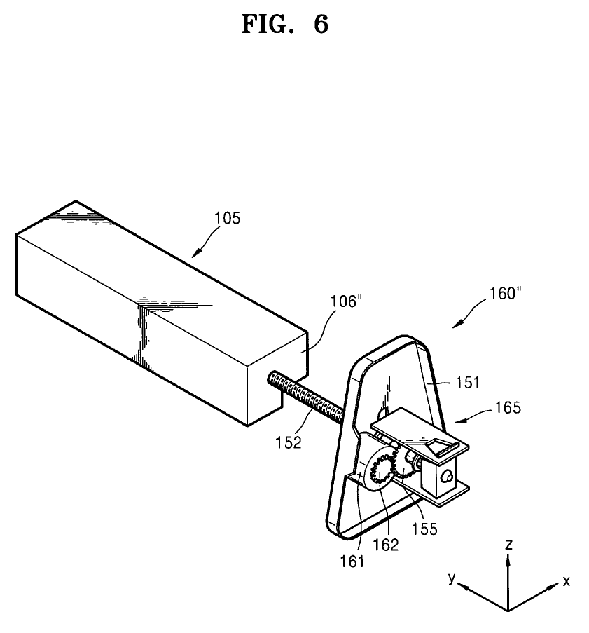

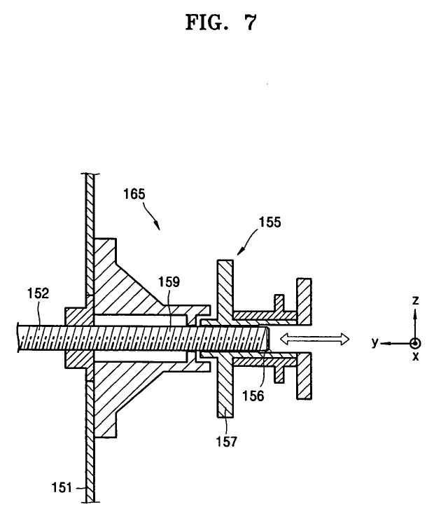

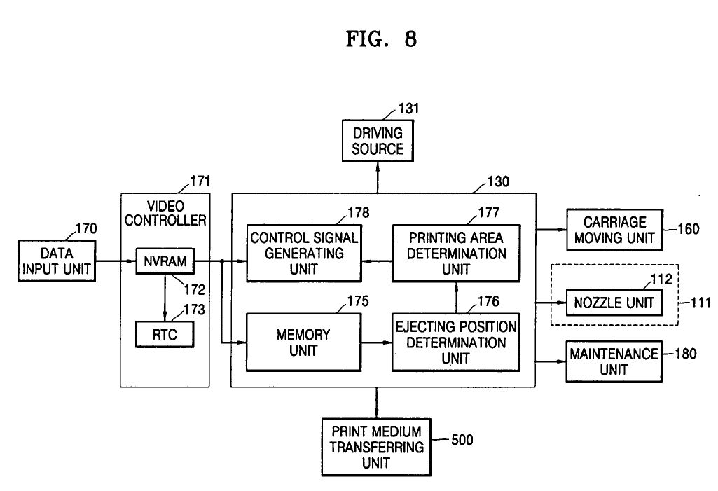

FIG. 4 is a perspective view illustrating a carriage moving unit 160 according to an embodiment of the present general inventive concept. FIG. 5 is a perspective view illustrating a carriage moving unit 160′ according to another embodiment of the present general inventive concept. FIG. 6 is a perspective view illustrating a carriage moving unit 160″ according to yet another embodiment of the present general inventive concept. FIG. 7 is a cross-sectional view illustrating the carriage moving unit 160″ of FIG. 6.

Referring to FIGS. 4 and 5 in conjunction with FIG. 2, the printhead 111 is mounted in the carriage 106 (106′). The carriage moving unit 160 (160′) reciprocally moves the carriage 106 between the first maintenance region 150A and the second maintenance region 150B. The carriage moving unit 160 (160′) includes a driving unit 162 to reciprocally move the carriage 106 (106′) along the second direction (i.e., the y direction).

A piezoelectric device used to accurately drive a device such as an optical mirror can be used as the driving unit 162. The piezoelectric device driven by an electric voltage has a position accuracy of several microns (μm) and a high frequency response characteristic. Accordingly, when the driving unit 162 is the piezoelectric device, the position of the carriage 106 (106′) can be accurately controlled. In the present embodiment, a case in which the carriage 106 (106′) is reciprocally moved using the piezoelectric actuator is described as an example, but the present general inventive concept is not limited thereto. Other driving devices may alternatively be used.

Referring to FIG. 4, the carriage moving unit 160 may further include a guide unit 108 to guide the reciprocal motion of the carriage 106. The guide unit 108 may include a combining unit 107 and a guide shaft 108A. The combining unit 107 is perforated at one side of the carriage 106. The guide shaft 108 is installed in the main frame (not illustrated) and inserted into the combining unit 107 formed in a hollow shape and guides the reciprocating motion of the carriage 106. That is, the carriage 106 is installed to slide with respect to the guide shaft 108A. Alternatively, referring to FIG. 5, the guide unit 108′ may include guide rails 108B. The guide rails 108B are installed at one or both sides of the carriage 106′ and guide the reciprocal motion of the carriage 106′.

In addition, referring to FIGS. 4 and 5, a pulse motor or a step motor may be used for the carriage moving unit 160 (160′). A moving distance of the carriage 106 (106′) may be controlled by the motor and an encoder sensor.

Referring to FIGS. 6 and 7, the carriage moving unit 160″ is connected to the carriage 106″ and includes a guide rod 152 extending along the second direction (i.e., y direction) and a reciprocal driving unit 165 which reciprocally moves the guide rod 152 along the second direction (i.e., the y direction). A lead screw 159 meshing with a female gear of a connection gear 155, which will be described later, is formed on an outer circumference of the guide rod 152. The reciprocal driving unit 165 includes a frame 151 fixed in the image forming apparatus 125 (see FIG. 1), the connection gear 155 having an inner circumference 156 with the female gear to mesh with a gear of the lead screw 159 and an outer circumference 157 of the connection gear 155 has gear teeth. A driving motor 161 is fixed at the frame 151. The driving motor 161 includes a gear 162 to mesh with and transmit a driving force to the connection gear 155. When the gear 162 driven by the driving motor 161 rotates forwardly or reversely, the connection gear 155 meshing with the gear 162 rotates to transmit the driving force to the lead screw 159 meshing with the inner circumference 156 of the connection gear 155, and thus the guide rod 152 is reciprocally moved along the second direction (i.e., the y direction). The carriage 106″ connected to the guide rod 152 is also moved along the second direction (i.e., the y direction).

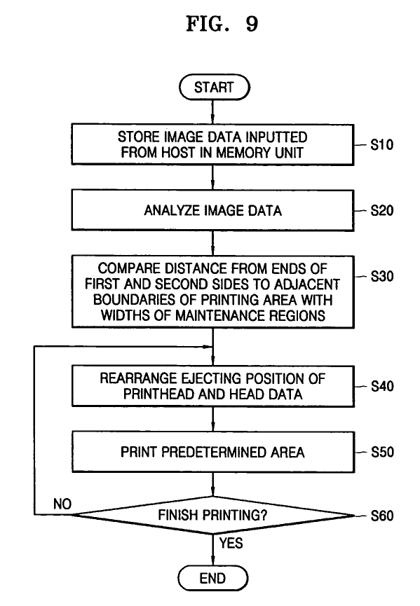

FIG. 8 is a block diagram illustrating the structure of an inkjet image forming apparatus according to an embodiment of the present general inventive concept. FIG. 9 is a flowchart illustrating a method of maintaining a printhead according to an embodiment of the present general inventive concept. The inkjet image forming apparatus of FIG. 8 may be similar to the inkjet image forming apparatus 125 of FIG. 1. Additionally, the method of FIG. 9 may be performed by the inkjet image forming apparatus of FIG. 2 or 8. Accordingly, for illustration purposes, the inkjet image forming apparatus of FIG. 8 and the method of FIG. 9 are described below with reference to FIGS. 1 to 9.

Referring to FIG. 8, the inkjet image forming apparatus includes a data input unit 170, a video controller 171, the carriage moving unit 160 (160′, 160″), the printhead 111 having the nozzle unit 112, the driving source 131, a maintenance unit 180, the print medium transferring unit 500, and the control unit 130.

The data input unit 170 receives image data to be printed from an external device such as a personal computer (PC), a digital camera, or a personal digital assistant (PDA). It should be understood that the image data may also include text data and, in general, any type of printable data.

The video controller 171 includes a non-volatile random access memory (NVRAM) 172, a real time clock (RTC) 173 and one or more of a static random access memory (SRAM, not illustrated), a synchronous dynamic random access memory (SDRAM, not illustrated), and a NOR Flash memory (not illustrated). The video controller 171 interprets the image data input into the data input unit 170 to convert the image data into corresponding bitmaps and transmits the bitmaps to the control unit 130. The control unit 130 transmits the bitmaps to each component of the image forming apparatus to print an image on the print medium P.

The control unit 130 is mounted on a motherboard (not illustrated), and generates control signals to control the operations of the printhead 111, the carriage moving unit 160 (160′, 160″), and other components so as to determine ejecting positions of the nozzle unit 112 with respect to the position of the printhead 111 moved by the carriage moving unit 160 (160′, 160″). The control unit 130 includes a memory unit 175, a printing area determination unit 177, an ejecting position determination unit 176, and a control signal generating unit 178. The memory unit 175 stores the image data input through the data input unit 170, and the control unit 130 verifies whether the storing of the image data in the memory unit 175 is complete and various printing environment information, such as a printing area. The printing area determination unit 177 reads the image data from the memory unit 175 and calculates distances between the ends of the first and second sides Y1 and Y2 and the respective adjacent boundaries of the printing area where the image data is printed. The printing area PA is determined as an area to which ink is to be ejected by the printhead 111 to form the image. The ejecting position determination unit 176 determines an ejecting position of the nozzle unit 112 by comparing (1) the distances D and D′ between the ends of the first and second sides Y1 and Y2 and the adjacent boundaries of the printing area and (2) the widths C of the maintenance regions 150. In addition, the ejecting position determination unit 176 rearranges head data, which will be described later, such that the ink droplets are ejected by the nozzle unit 112 in desired areas of the print medium P after determining the ejecting position of the nozzle unit 112. The control signal generating unit 178 generates and outputs control signals to control the operations of the components of the image forming apparatus according to data input from the video controller 171 and the ejecting position determination unit 176. The image forming apparatus performs a printing operation by moving the printhead 111 according to the control signals.

Hereinafter, the operation of the control unit 130 will be described in detail with reference to the flowchart of FIG. 9 illustrating the method of maintaining the printhead 111 according to an embodiment of the present general inventive concept.

Referring to FIGS. 1 to 9, the image data input from a host is stored in the memory unit 175 in operation S10.

The printing area determination unit 177 reads the image data from the memory unit 175 and analyzes the image data in operation S20. That is, the printing area determination unit 177 calculates a distance of a marginal area, that is, distances D and D′ between the ends of the first and second sides Y1 and Y2 and the adjacent boundaries of the printing area where the image data is to be printed.

The ejecting position determination unit 176 compares (1) the distances D and D′ between the ends of the first and second sides Y1 and Y2 and the adjacent boundaries of the printing area with the (2) widths C of the maintenance regions 150 in operation S30.

In addition, the ejecting position determination unit 176 determines the ejecting position of the nozzle unit 112 and rearranges the head data such that ink droplets ejected from each of the nozzles is deposited on a desired position of the print medium P according to the resultant ejecting positions determined in operation S40. In other words, the ejecting position determination unit 176 is capable of rearranging the head data that corresponds to a particular nozzle or group of nozzles such that the head data is set to correspond to another nozzle or group of nozzles. Alternatively, the ejecting position determination unit 176 may receive and set the head data to initially correspond to the nozzles that are in position to print to the printing area. The control unit 130 operates the carriage moving unit 160 (160′, 160″) to move the printhead 111 to a predetermined position according to the comparison of the distances D and D′ between the ends of the first and second sides Y1 and Y2 and the adjacent boundaries of the printing area with the widths C of the maintenance regions 150 calculated by the ejecting position determination unit 176.

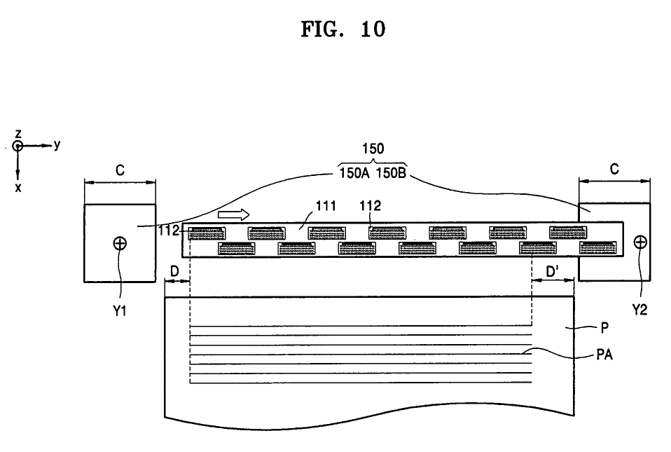

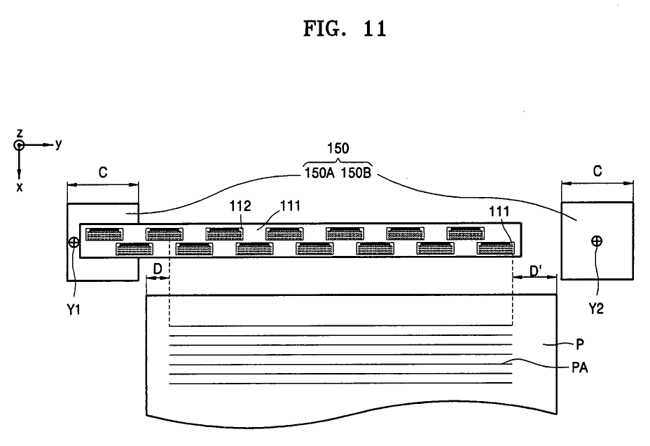

The operation S40 will be described in detail with reference to FIGS. 10 to 13.

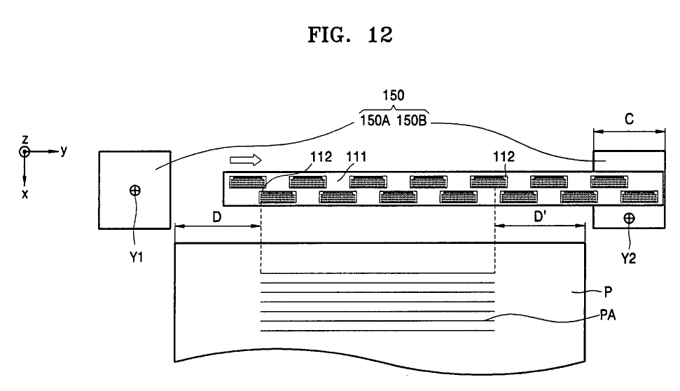

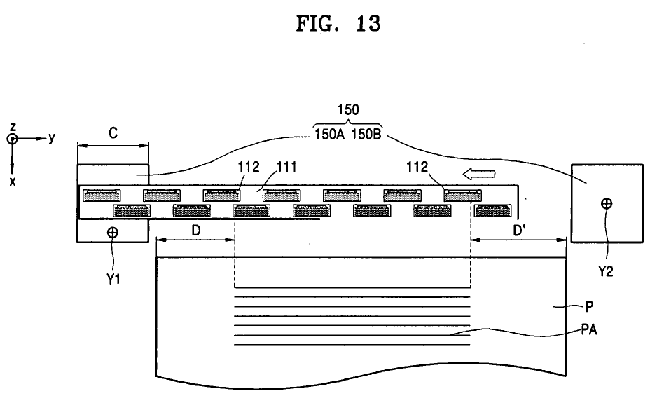

FIGS. 10 and 11 illustrate operations of maintaining the printhead 111 according to an embodiment of the present general inventive concept. FIGS. 12 and 13 illustrate operations of maintaining the printhead 111 according to another embodiment of the present general inventive concept. Like reference numerals in the drawings represent like elements having similar structures and functions as illustrated in FIG. 2, etc.

Referring to FIGS. 10 and 11, the case in which the distances D and D′ between the ends of the first and second sides Y1 and Y2 and the adjacent boundaries of a printing area PA are shorter than the widths C of the maintenance regions 150 will be described.

Referring to FIG. 10, the control unit 130 generates a control signal to control the carriage moving unit 160 (160′, 160″) to move the carriage 106 (106′, 106″) toward the second side Y2 (indicated by a white arrow) such that the nozzles at an end of the nozzle unit 112 at the first side Y1 print the image data at an end of the first side Y1 of the printing area PA. The control unit 130 rearranges the head data such that the nozzles at the end of the nozzle unit 112 at the first side Y1 print the image data at the end of the first side Y1 of the printing area PA and nozzles at the end of the nozzle unit 112 at the second side Y2 do not print to the second maintenance region 150B. Here, the head data indicates data transmitted to the nozzle unit 112 so as to print the corresponding image data using selected nozzles. The head data determines whether each of the nozzles in the nozzle unit 112 are driven to eject ink. When the head data is rearranged, the control unit 130 controls the operations of the printhead 111 to print the image data to a predetermined area (e.g., a unit of one or more lines, a unit of a page of the printing medium P, a unit of a print job, etc.) within the printing area PA in operation S50. The end of the printing operation is determined in operation S60 after printing the image data on the predetermined area. A gap between a first side of the nozzle unit 112 and a first side of the printing area PA may vary during a printing operation of the printing medium, and a second gap between a second side of the nozzle unit 112 and a second side of the printing area PA may also vary, so that different sets of nozzle chips or nozzles of each head chip H can be used to print according to the image data, the gaps, and/or the distances D, D′.

As illustrated in FIG. 11, when the printing operation is not complete, the control unit 130 generates a control signal to control the operation of the carriage moving unit 160 (160′, 160″) to move the carriage 106 (106′, 106″), where the printhead 111 is mounted, toward the first side Y1 such that nozzles in the end of the nozzle unit 112 at the second side Y2 print the image data at the end of the second side Y2 of the printing area PA. The control unit 130 rearranges the head data such that nozzles in the end of the nozzle unit 112 at the second side Y2 print the image data at the end of the second side Y2 of the printing area PA and nozzles at the end of the nozzle unit 112 at the first side Y1 do not print to the first maintenance region 150A. When the head data is rearranged, the control unit 130 controls the operation of the printhead 111 to print the image data to another a predetermined area in the printing area PA in the operation S50. The operations described above are iteratively performed until the printing operation is complete. In other words, the control unit 130 may alternate between using the nozzles in the nozzle unit 112 at the second side Y2 to print the second side of the printing area PA while the nozzles in the nozzle unit 112 at the first side Y1 are maintained in the first maintenance region 150A by the maintenance unit 180, and using the nozzles in the nozzle unit 112 at the first side Y1 to print the first side of the printing area PA while the nozzles in the nozzle unit 112 at the second side Y2 are maintained in the second maintenance region 150B by the maintenance unit 180. According to these alternating operations for printing operations performed on each predetermined area, an ejecting load on certain nozzles in the nozzle unit 112 can be varied while other nozzles are maintained by the maintenance unit 180. Additionally, the maintenance operation can be performed simultaneously with the printing operation. Alternatively, the maintenance operation may be performed at a different time.

Referring to FIGS. 12 and 13, the case in which the distances D and D′ between the ends of the first and second sides Y1 and Y2 and the adjacent boundaries of the printing area PA are equal to or greater than the width C of the maintenance regions 150 will be described.

When the distance D or D′ is equal to or greater than the width C, the printing operation using the same type of reciprocal motion of the carriage 106 (106′, 106″) where the printhead 111 is mounted as illustrated in FIGS. 10 and 11 may be impossible. Accordingly, as illustrated in FIG. 12, the control unit 130 generates a control signal to move the end of the second side Y2 of the carriage 106 (106′, 106″), where the printhead 111 is mounted, to the end of the second side Y2 of the second maintenance region 150B, and determines the ejecting position of the nozzle unit 112 to print the image data on the printing area PA. The control unit 130 rearranges the head data such that nozzles in the nozzle unit 112 that are moved to print to the printing area PA are driven. When the head data is rearranged, the control unit 130 controls the operation of the printhead 111 to print the image data on a predetermined area (e.g., a unit of one or more lines, a unit of a page of the printing medium P, a unit of a print job, etc.) within the printing area PA in the operation S50. The end of printing operation is determined in the operation S60 after printing the image data on the predetermined area.

As illustrated in FIG. 13, when the printing operation is not complete, the control unit 130 generates a control signal to move the end of the first side Y1 of the carriage 106, where the printhead 111 is mounted, to the end of the first side Y1 of the first maintenance region 150A, and determines the ejecting position of the nozzle unit 112 so as to print the image data on the printing area PA. The control unit 130 rearranges the head data such that nozzles in the nozzle unit 112 that are moved to print the image data to the printing area PA are driven. When the head data is rearranged, the control unit 130 controls the operation of the printhead 111 to print the image data on another predetermined area in the printing area PA in the operation S50. The operations described above are iteratively performed until the printing operation is complete.

Like in the embodiments of FIGS. 10 through 13, the control unit 130 generates a control signal to move the carriage 106 (106′, 106″), where the printhead 111 is mounted, after a predetermined region of the print medium P is printed. Whenever a predetermined region is printed, the control unit 130 controls the printhead 111 to move along the second direction (i.e., the y direction). For example, after printing one page of the print medium P, the control unit 130 may move the carriage 106 where the printhead 111 is mounted. Additionally, after the printing of one page of the print medium P is complete, a predetermined time interval occurs before a new page of the print medium P is transferred to the printhead 111. Therefore, a printing speed can be increased by the operations of moving the printhead 111 during the predetermined time interval in which the printing operation is not actually being performed, and then a next predetermined area (i.e., the new page of the print medium P) can be printed. Thus, the predetermined area may correspond to a page of the print medium P. Alternatively, the predetermined area may correspond to a predetermined number of lines, a print job, etc.

In addition, a portion of the nozzle unit 112 in the printhead 111 is positioned in the maintenance regions 150 during printing. Accordingly, the control unit 130 may operate the maintenance unit 180 so as to maintain unused nozzles positioned in the maintenance unit 150 in a standby state to provide optimum printing quality. That is, the control unit 130 controls the maintenance unit 180 to perform the maintenance operation for unused nozzles positioned in the maintenance regions 150 for the next printing operation. The control unit 130 may control the period of the maintenance operation according to a structure of the printhead 111 or ink properties.

In addition, the control unit 130 generates a control signal such that the carriage 106 (106′, 106″), where the printhead 111 is mounted, moves a variable distance. When printing to a plurality of the printing media P, the control unit 130 moves the printhead 111 along the second direction (i.e., the y direction) for printing. The moving distance of the printhead 111 may be varied for printing so as not to concentrate an ejecting load on certain nozzles of the nozzle unit 112. For example, when the image data is printed on ten pages of printing media P, the nozzles printing to the ends of the first sides Y1 of 1st, 3rd, 5th, 7th, and 9th pages of the printing media P and the nozzles printing to the ends of the second sides Y2 of 2nd, 4th, 6th, 8th, and 10th pages of the printing media P may be different from each other during the printing operation. Accordingly, when the printing operation is performed while varying the moving distance of the carriage 106 (106′, 106″), the concentration of the ejecting load on certain nozzles can be prevented, thereby increasing a lifespan of the nozzles.

The image forming apparatus may further include a nozzle memory (not illustrated) where ejecting times of the nozzle unit 112 are stored in units of nozzles or groups of nozzles. The structures and functions of the nozzle memory should be known to those of skill in the art, and thus a detailed description thereof will not be provided. The control unit 130 generates a control signal to move the carriage 106 according to the nozzle information stored in the nozzle memory. The nozzle memory stores the ejecting time for each of the nozzles or of groups of nozzles. Accordingly, the control unit 130 controls the ejecting positions of nozzles in the nozzle unit 112 according to the stored information in the nozzle memory and prevents the concentration of the ejection load on specific nozzles.

According to the above described structures and methods, the various embodiments of the present general inventive concept can prevent concentration of an ejection load on specific nozzles by reciprocally moving the printhead 111 to eject ink on the print medium P.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software. For example, the control unit 130 may be implemented in software.

A method of maintaining a printhead of an inkjet image forming apparatus of the various embodiments of the present general inventive concept controls each nozzle in the printhead to evenly eject ink, thereby increasing a lifespan of the printhead. For example, the printhead according to the various embodiments of the present general inventive concept is reciprocally moved to print such that the lifespan of the printhead is at least twice as long as that of a fixed printhead. In addition, the embodiments of the present general inventive concept perform a maintenance operation on unused nozzles during a printing operation, thereby increasing the lifespan of the printhead and enhancing a printing quality. The inkjet image forming apparatus according to the embodiments of the present general inventive concept stops the printhead from moving for printing a predetermined area and then moves the printhead again, and thus can provide a more reliable printing quality because factors that adversely affect the printing quality that are typically present in shuttle-type printheads can be reduced. In addition, the embodiments of the present general inventive concept sets up only a position of a print medium so that a precise motor control is not necessary and thus a manufacturing cost of the image forming apparatus can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a printhead installed along a first direction with respect to a print medium that is transferred along a second direction and having a nozzle unit with a length corresponding to at least a width of the print medium;
maintenance regions including a first maintenance region disposed at a first side of a longitudinal direction of the printhead and a second maintenance region disposed at a second side opposite to the first side;
a carriage in which the printhead is mounted;
a carriage moving unit to reciprocally move the carriage between the first and the second maintenance regions; and
a control unit which generates a control signal to control operations of the printhead and the carriage moving unit to determine an ejecting position of the nozzle unit according to a position of the printhead moved by the carriage moving unit.

2. The apparatus of claim 1, wherein the control unit comprises:
a memory unit to store image data input from an external device;
a printing area determination unit to read the image data from the memory unit, and to calculate distances from ends of the first and second sides of the print medium to respective adjacent boundaries of a printing area where the image data is to be printed by reading the image data from the memory unit; and
an ejecting position determination unit to compare the distances between the ends of the first and second sides of the print medium and the respective adjacent boundaries of the printing area with widths of the maintenance regions, and to determine the ejecting position of the nozzle unit, accordingly.

3. The apparatus of claim 2, wherein the control unit generates a control signal to move the carriage toward the second side such that the nozzles at an end of the first side of the nozzle unit print to an end of the first side of the printing area on the print medium when the distance between the end of the first side of the print medium and the respective adjacent boundary of the printing area is shorter than the widths of the maintenance regions.

4. The apparatus of claim 3, wherein the control unit generates a control signal to move the carriage to the first side such that nozzles at an end of the second side of the nozzle unit print to an end of the second side of the printing area after printing to a predetermined area of the print medium.

5. The apparatus of claim 2, wherein the control unit generates a control signal to move an end of the second side of the carriage to an end of the second side of the second maintenance region and to determine the ejecting position of the nozzle unit to print the image data on the printing area when the distance between the end of the first side of the print medium and the adjacent boundary of the printing area is greater than or equal to the widths of the maintenance regions.

6. The apparatus of claim 5, wherein the control unit generates a control signal to move an end of the first side of the carriage to an end of the first side of the first maintenance region and to determine the ejecting position of the nozzle unit to print the image data on the printing area after printing to a predetermined area of the print medium.

7. The apparatus of claim 2, further comprising:
a maintenance unit disposed in the maintenance regions to maintain the nozzle unit in a standby state, and the control unit generates a control signal to control the maintenance unit so that unused nozzles positioned in the maintenance regions are maintained in the standby state when a printing operation is being performed using other nozzles.

8. The apparatus of claim 2, wherein the control unit generates a control signal to move the carriage after printing to a predetermined area of the print medium.

9. The apparatus of claim 8, wherein the control unit generates a control signal to move the carriage after printing one page of the print medium.

10. The apparatus of claim 2, wherein the control unit generates a control signal to move the carriage by a moving distance such that the moving distance of the carriage varies each time the carriage is moved.

11. The apparatus of claim 2, further comprising:
a nozzle memory to store ejecting times of the nozzle unit in units of nozzles or predetermined groups of nozzles, and the control unit generates a control signal to move the carriage according to information stored in the nozzle memory.

12. An image forming apparatus, comprising:
a line array type printhead having a width that corresponds to a width of a printing medium; and
a control unit to vary a position of the printhead along the width of the printing medium during one or more print operations such that an ejection load on nozzles in the printhead is not concentrated in one or more regions of the printhead.

13. An image forming apparatus, comprising:
a printhead having a width that corresponds to a width of a print medium;
a control unit to move the printhead between at least two positions with respect to the print medium; and
an ejecting position determination unit to receive print data to be printed in a next print operation and a current position of the printhead with respect to the print medium, and to generate head data to control selected nozzles in the printhead to print in the next print operation based on the received print data and the current position of the printhead.

14. An image forming apparatus, comprising:
a printhead having a plurality of nozzles;
a support along which a print medium is transferred;
at least one maintenance region disposed on at least one side of the support adjacent to the print medium; and
a control unit to control nozzles in a first portion of the printhead to print a line of print data on the print medium while nozzles in a second portion of the printhead are maintained in the at least one maintenance region.

15. An image forming apparatus, comprising:
a printhead having a plurality of nozzles arranged along a width of a printing medium to perform one or more printing operations; and
a control unit to receive print data, to determine a print area on the printing medium according to the received print data, and to move the printhead to alternate between at least two positions such that nozzles that perform the one or more printing operations and nozzles that are in a standby state are varied for each printing operation.

16. An image forming apparatus, comprising:
a print head having nozzles;
a maintenance unit to maintain the nozzles; and
a control unit to move the print head such that a portion of the nozzles is disposed in a printing area of a print medium to print and a second portion of the nozzles is disposed in the maintenance unit to perform a maintenance.

17. An image forming apparatus, comprising:
a print head having nozzles; and
a control unit to move the print head to choose a position with respect to a print medium, to determine a set of the nozzles of the print head to print according to the position of the print head with respect to the print medium.

18. An apparatus to maintain a printhead of an inkjet image forming apparatus which includes maintenance regions having a first maintenance region disposed at a first side of a longitudinal direction of a printhead having a nozzle unit with a length corresponding to a width of a print medium and a second maintenance region disposed at a second side opposite to the first side, the apparatus comprising:
a print area unit to calculate distances between ends of the first and second sides of the print medium and respective adjacent boundaries of a printing area where image data is to be printed by analyzing the image data input from an external device; and
an ejection nozzle position unit to determine an ejecting position of the printhead by comparing the distances between the ends of the first and second sides of the print medium and the respective adjacent boundaries of the printing area with widths of the maintenance regions.

19. A method of maintaining a printhead of an inkjet image forming apparatus which includes maintenance regions having a first maintenance region disposed at a first side of a longitudinal direction of a printhead having a nozzle unit with a length corresponding to a width of a print medium and a second maintenance region disposed at a second side opposite to the first side, the method comprising:
calculating distances between ends of the first and second sides of the print medium and respective adjacent boundaries of a printing area where image data is to be printed by analyzing the image data input from an external device; and
determining an ejecting position of the printhead by comparing the distances between the ends of the first and second sides of the print medium and the respective adjacent boundaries of the printing area with widths of the maintenance regions.

20. The method of claim 19, further comprising:
moving the printhead toward the second side for printing such that nozzles at an end of the first side of the nozzle unit print to an end of the first side of the printing area when the distance between the end of the first side of the print medium and the respective adjacent boundary of the printing area is shorter than the widths of the maintenance regions.

21. The method of claim 20, further comprising:
moving the printhead toward the first side for printing such that nozzles at an end of the second side of the nozzle unit print to an end of the second side of the printing area after printing a predetermined area.

22. The method of claim 19, further comprising:
moving an end of the second side of the printhead toward an end of the second side of the second maintenance region for printing when the distance between the end of the first side of the print medium and the adjacent boundary of the printing area is greater than or equal to the width of the maintenance region.

23. The method of claim 22, further comprising:
moving an end of the first side of the printhead toward an end of the first side of the first maintenance region for printing after a predetermined area of the print medium is printed.

24. The method of claim 19, further comprising:
maintaining the nozzle unit in a standby state using maintenance units disposed in the maintenance regions and operating the maintenance units so that unused nozzles positioned in the maintenance regions are maintained in the standby state when printing to the printing area.

25. The method of claim 19, further comprising:
moving the printhead after printing to a predetermined area of the print medium.

26. The method of claim 25, further comprising:
moving the printhead after printing one page of the print medium.

27. The method of claim 19, further comprising:
reciprocally moving the printhead, wherein a moving distance of the printhead varies each time the printhead is moved.

28. The method of claim 19, further comprising:
storing ejecting times of the nozzle unit in units of nozzles or predetermined groups of nozzles in a nozzle memory and performing the printing by moving the printhead according to information stored in the nozzle memory.

29. A method of controlling an image forming apparatus having a printhead with a plurality of nozzles, a support along which a print medium is transferred, and at least one maintenance region disposed on at least one side of the support adjacent to the print medium, the method comprising:
controlling nozzles in a first portion of the printhead to print a line of print data on the print medium while nozzles in a second portion of the printhead is maintained in the at least one maintenance region.

30. The method of claim 29, wherein the controlling of the nozzles in the first portion of the printhead to print the line of print data on the print medium while nozzles in the second portion of the printhead are maintained in the at least one maintenance region comprises:
receiving print data from an external device;
determining a margin associated with the print data;
moving the first portion of the printhead within the margin to print a first predetermined portion of the print data while a second portion of the printhead is in a standby state outside the margin; and
moving the second portion of the printhead within the margin to print a second predetermined portion of the print data while the first portion of the printhead is in the standby state outside the margin.

31. The method of claim 29, wherein the controlling of the nozzles in the first portion of the printhead to print the line of print data on the print medium while the nozzles in the second portion of the printhead are maintained in the at least one maintenance region comprises:
receiving print data to be printed on the print medium;
moving the printhead such that the first portion and a third portion of the printhead print a predetermined portion of the print data while the second portion of the printhead is maintained in the at least one maintenance region; and
moving the printhead such that the second and third portions of the printhead print another predetermined portion of the printhead while the first portion of the printhead is maintained in the at least one maintenance region.

32. A method of controlling an image forming apparatus having a line array type printhead with a width that corresponds to a width of a printing medium, the method comprising:
controlling movement of the printhead to vary a position of the printhead along the width of the printing medium during one or more print operations such that an ejection load on nozzles in the printhead is not concentrated in one or more regions of the printhead.

33. The method of claim 32, wherein the controlling of the movement of the printhead comprises:
moving the printhead to a first position for a first print operation; and
moving the printhead to a second position for a second print operation.

34. The method of claim 33, wherein the first print operation comprises printing a first page of print data and the second print operation comprises printing a second page of print data, and the method further comprises:
moving the printhead between the first and second positions while a first page of the printing medium on which the first print operation is performed is discharged and a second page of the printing medium is loaded under the printhead.

35. The method of claim 33, wherein the first and second print operations comprise one of printing first and second groups of print lines, respectively, and performing first and second print jobs, respectively.

36. The method of claim 32, wherein the controlling of the movement of the printhead comprises moving the printhead by a different amount along the width of the printing medium between each print operation performed by the printhead.

37. The method of claim 32, wherein the controlling of the movement of the printhead comprises:
receiving print data from an external device;
determining a margin associated with the print data;
moving a first portion of the printhead within the margin to print a first predetermined portion of the print data while a second portion of the printhead is in a standby state outside the margin; and
moving the second portion of the printhead within the margin to print a second predetermined portion of the print data while the first portion of the printhead is in the standby state outside the margin.
